(19) United States
(12) Patent Application Publication
(10) Pub. No.: US 2013/0191122 A1
(43) Pub. Date: Jul. 25, 2013

(54) Voice Electronic Listening Assistant

(71) Applicant: Justin Mason, Aliso Viejo, CA (US)

(72) Inventor: Justin Mason, Aliso Viejo, CA (US)

(21) Appl. No.: 13/557,088

(22) Filed: Jul. 24, 2012

Related U.S. Application Data
(63) Continuation of application No. PCT/US11/22359, filed on Jan. 25, 2011.
(60) Provisional application No. 61/297,934, filed on Jan. 25, 2010.

(51) Int. Cl. G10L 15/08

(52) U.S. Cl. CPC G10L 15/08
USPC 704/231

(57) ABSTRACT

The invention comprises music and information delivery systems and methods. One system comprises a voice activated sound system wherein a user speaks and the sound system recognizes the speech and searches an internet database like Rhapsody™ to obtain a list of matching audio files and display the list on a dashboard screen of a vehicle. The user is able to identify the audio file by voice activation and the system is configured to receive the audio file.

### CROSS-REFERENCE TO RELATED APPLICATION

This application claims priority to PCT application number PCT/US11/22359 filed Jan. 25, 2011 which claims priority to United States provisional application No. 61/297,934 dated Jan. 25, 2010 the contents of the applications are hereby incorporated by reference.

### BACKGROUND OF THE INVENTION

The present invention relates in general to retrieving audio files which can be played on a sound system in a vehicle, and more particularly to a system that utilizes voice recognition to access a database from a vehicle via the internet with voice recognition software that allows hands-free searching and acquisition of the audio file.

U.S. Pat. No. 7,444,353 issued to Chen discloses an apparatus for delivering music and information. However, Chen does not recognize song names spoken by a user for song title search to an internet database updated real-time. Further, Chen does not have technology for voice recognition that will convert spoken words in a digital medium/text that is usable by the internet database for music search. Further, Chen does not have new song search feature. Further, Chen does not have voice playback commands and voice music file storage and sort commands.

United States Patent Publication 20020156759 published for Santos discloses system for transmitting messages. However, Santos system relies on a mobile phone and is not integrated into a vehicle. Further, Santos does not have a new song search feature.

United States Patent Publication 20030050058 published for Walsh discloses dynamic content delivery responsive to a user request. However, Walsh discloses a jukebox that is not hands free and the system requires a Bluetooth™ to connect to other equipment like a cell phone that has wireless capabilities.

United States Patent Publication 20040030691 published for Woo discloses music search engine. However, Woo searches for songs based upon short sequences of musical notes and attempts to match songs. Woo does not disclose the use of a wireless internet connection for real time updated song database access. Further, Woo does not disclose a system of for music commands; start/stop/pause that can be actuated through voice command.

United States Patent Publication 20040199387 published for Wang discloses a method and system for purchasing pre-recorded music. Further, Wang discloses a system that requires a user to call a phone number and play a sample of the song.

United States Patent Publication 20050201254 published for Looney discloses a media organizer and entertainment center. Further, Looney discloses a system for audio file playback utilizing compressed data files. However, Looney does not have a real time database or an internet connection for accessing an audio file database.

United States Patent Publication 20050227674 published for Kopra discloses a mobile station and interface adapted for feature extraction from an input media sample. However, Kopra requires the use of a mobile phone to record a music sample that can be used to search for a song title.

United States Patent Publication 20070192038 published for Kameyama discloses a system for providing vehicular hospitality information. However, the system is designed to detect a user's mood to help decipher types of music to play.

United States Patent Publication 20070250319 published for Tateishi discloses a song search system that utilizes short phrases from the song and the mood of the user in order to identify possible song matches. However, Tateishi does not disclose an internet accessible audio file database.

This is accomplished through complete voice command control of all features of internet music access, search, playback, sort, and storage.

The above referenced patents and patent applications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

Therefore, it is an object of the present invention to provide a system to provide hands-free access to a remote database via the internet and controlled by voice recognition.

A further object is to provide a system that utilizes voice recognition software that a user can speak the name of a song or part of the name of a song or audio file and the software can create a list and display the list of audio files available from a remote server or services such as Rhapsody™.

Although various audio systems are known to the art, all, or almost all of them suffer from one or more than one disadvantage. Therefore, there is a need to provide an improved hands-free audio file acquisition system and method of use.

### SUMMARY OF THE INVENTION

The present invention relates in general to retrieving audio files which can be played on a sound system in a vehicle, and more particularly to a system that utilizes voice recognition to access a database from a vehicle via the internet with voice recognition software that allows hands-free searching and acquisition of the audio file.

No other music application exists to holistically address the music needs of a driver. The product addresses all safety issues and concerns of a driver while also providing the ultimate music search database at their fingertips. This product is unprecedented in it approach to ease of music access catered to a customer who needs to be able to focus their attention to driving a motor vehicle. This software is fully integrated into a customer's car stereo system.

It is to be understood that the foregoing general description and the following detailed description are exemplary and explanatory only and are not to be viewed as being restrictive of the present invention, as claimed. Further advantages of this invention will be apparent after a review of the following detailed description of the disclosed embodiments which are illustrated schematically in the accompanying drawings and in the appended claims.

### BRIEF DESCRIPTION OF THE FIGURES

In the following, embodiments of the present invention will be explained in detail on the basis of the drawings, in which:

FIG. 1 is a diagram of the basic components necessary for a preferred embodiment.

FIG. 2 is a diagram of the components for a preferred speaking embodiment.

FIG. 3 is a perspective view of a preferred touch screen embodiment.

FIG. 4 is a simulated screen shot of a preferred embodiment.

### DETAILED DESCRIPTION

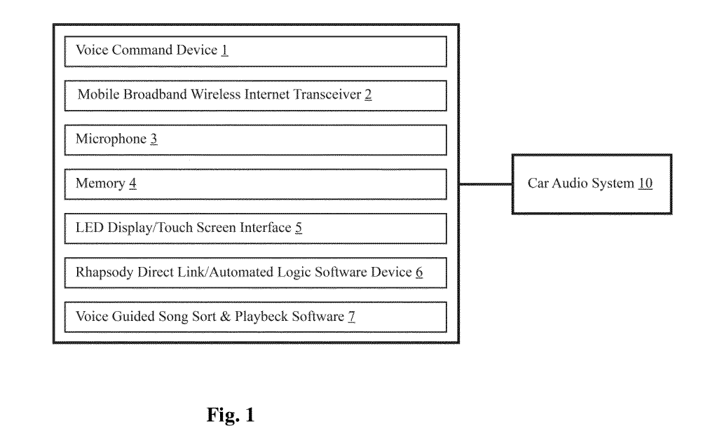

FIG. 1 shows a preferred embodiment wherein the basic components necessary for a functional voice or touch screen searchable database over the internet. In particular, a car audio system 10 would include a voice command device 1, mobile broadband wireless transceiver 2, microphone 3, memory 4, LCD display/touch screen interface 5, Rhapsody Direct Link/automated login software device 6, and voice guided song sort and playback software 7. In the present embodiment, a user would speak, “VELA play Alicia Keys' New Song.” The microphone 3 would receive the message from the user and a voice command device 1 would convert the message into a useable search command that would access the internet via Rhapsody Direct Link/automated login software device 6 and access remote audio file database (not shown). The voice command device 1 utilizes speech recognition software and sends commands to the internet via mobile broadband wireless transceiver 2. The matching audio files are sorted in chronologic order from their release date and the voice guided song sort and playback software 7 automatically begins to play the first audio file on the car audio system 10. The voice guided song sort and playback software 7 utilizes voice commands that are recognized from speech recognition on the voice command device 1 to navigate search results. If the audio file is not the audio file that the user wanted, the user can give another command, for example, speaking,

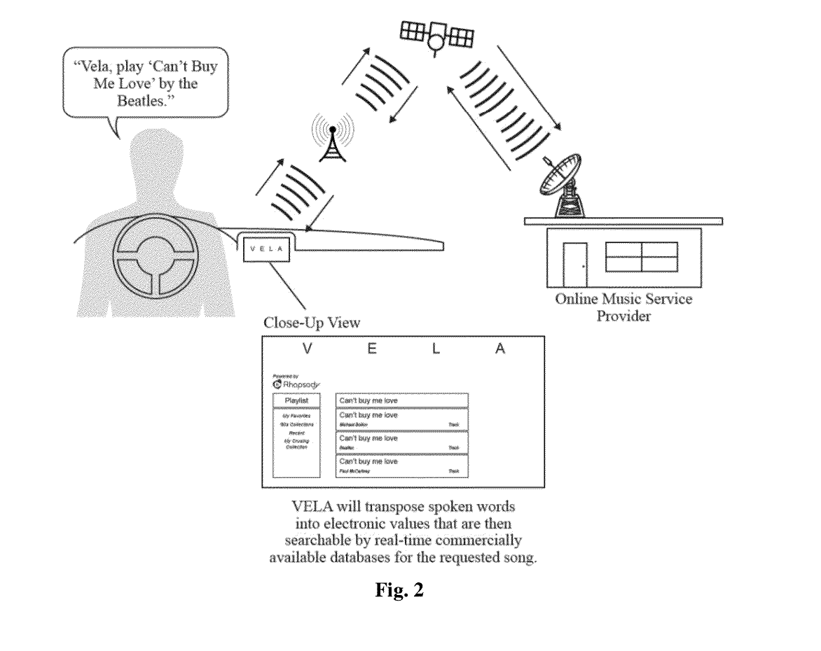

“Next.” The voice guided song sort and playback software 7 skips to the next audio file of the matching audio files in chronological order by release date. The process can be repeated until the matching audio files are exhausted. In the alternative, the user can speak additional command terms to navigate the voice guided song sort and playback software 7. FIG. 2 shows the preferred embodiment with a user speaking, “VELA, play Yellow submarine by the Beatles.” The matching audio files are displayed on the LCD display/touch screen interface 5. FIG. 2 further illustrates how the user message is communicated from the user to a microphone 3 and transmitted by mobile broadband transceiver 2 to a cellular tower (or equivalent) and further transmitted to a remote database (showed as communicating with a satellite).

In an alternative embodiment, the user can perform operations and navigate the audio files through the LCD display/touch screen interface 5. For example, the user could touch activate the preferred embodiment by push button on the LCD display/touch screen interface 5, the voice guided song sort and playback software 7 would display a search engine field on the LCD display/touch screen interface 5. The user could then type or use navigation buttons to acquire a playlist of audio files from a remote database.

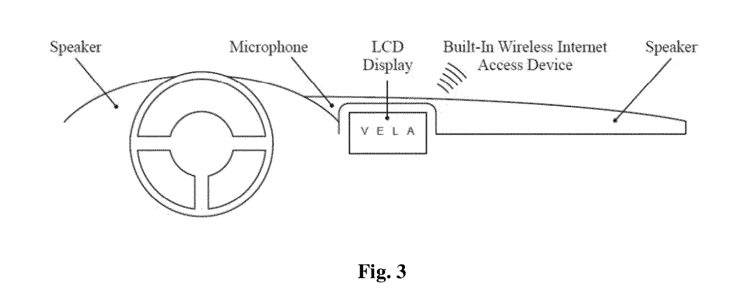

In an alternative embodiment the user could search with a voice command, “VELA, search No Doubt, Don't Speak.” The voice guided song sort and playback software 7 would populate the search box with the audio file “Don't Speak” by the artist “No Doubt” on the LCD display/touch screen interface 5 as written text. If the text matches the user intent, the user has the voice option command, “search” or a button on the LCD display/touch screen interface 5 that will signal the voice guided song sort and playback software 7 to request and acquire a list of matching audio files and display the list on the LCD display/touch screen interface 5. The user can view the list of audio files on the LCD display/touch screen interface 5. The user can then select the desired audio file by either touching the LCD display/touch screen interface 5 or using voice commands to select the audio file from the LCD display/touch screen interface 5. The preferred embodiment then plays the audio file through the vehicle speakers, see FIG. 3. If the text does not match the user intent, the user can use different voice commands to navigate, for example by speaking, “go back” or “clear” so that the user can re-try or there could be a “back,” “clear,” or “return” button on the LCD display/touch screen interface 5 to navigate.

In a preferred embodiment the car audio system is triggered to search remote databases automatically, wherein the trigger is the word, “VELA,” for example. In such a case, the trigger voice command would allow a user to maintain normal conversation while riding or operating the vehicle.

In a preferred embodiment the car audio system 10 could use search terms for artist name, album title, audio file name, or Boolean word search to match audio files available on the remote database. When Boolean word searches are performed, the voice guided song sort and playback software 7 automatically ranks the matching audio files by highest degree of matching. The voice guided song sort and playback software 7 can similarly rank matching audio files for searches performed on the artist name, album title and audio file name.

In a preferred embodiment, once the user has identified the audio file the user has the option of saving the audio file to a playlist. The user could use either voice command such as “save” or the user could push a save button on the LCD display/touch screen interface 5. The files could be saved to memory 4.

In a preferred embodiment the user could use the voice guided song sort and playback software 7 to create folders for sorting, arranging or otherwise manipulating audio files into playlists that are displayed on the LCD display/touch screen interface 5. The user could use either voice command such as “move audio file” or the user could push a save button on the LCD display/touch screen interface 5 to move or otherwise manipulate and arrange audio files.

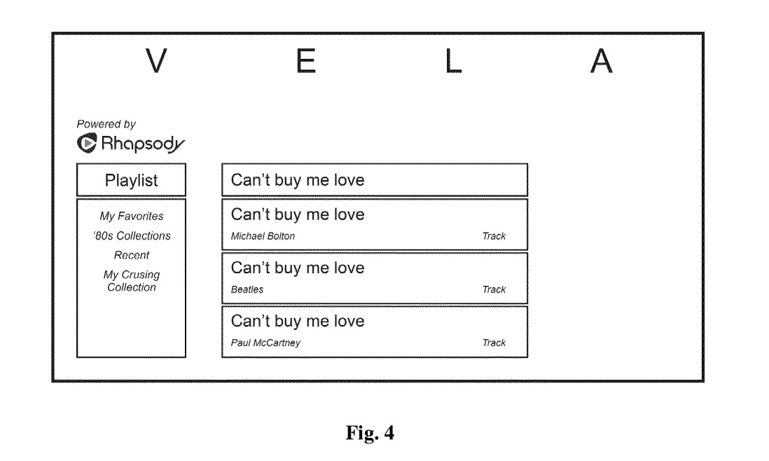

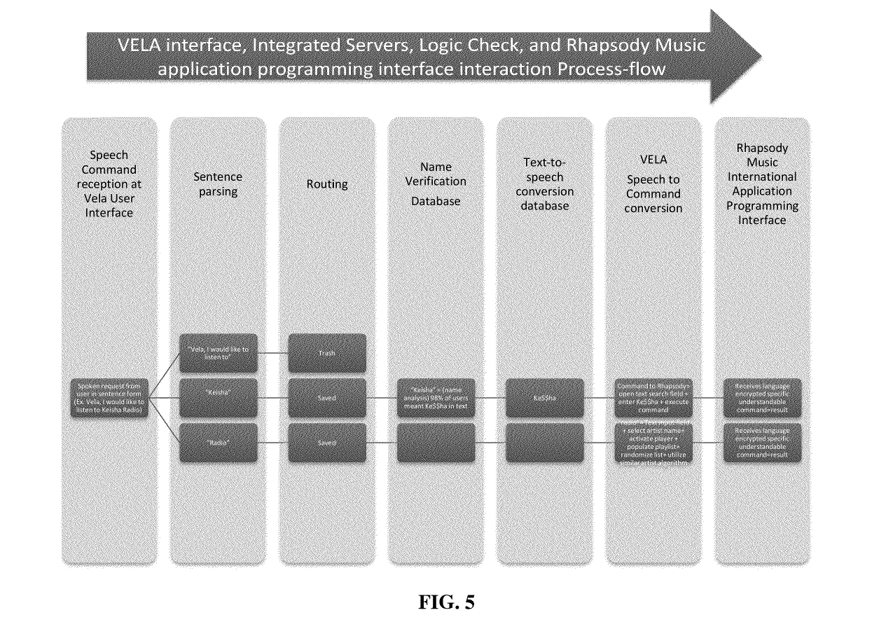

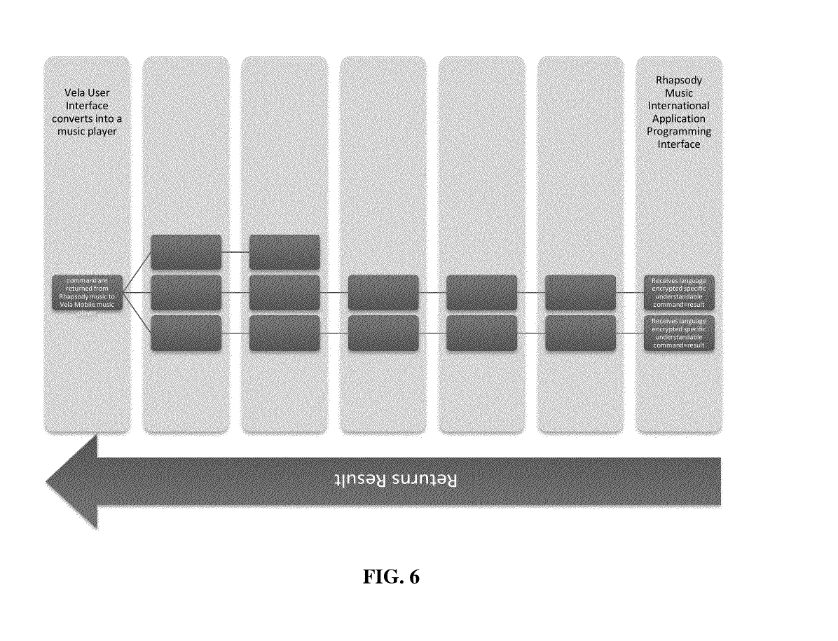

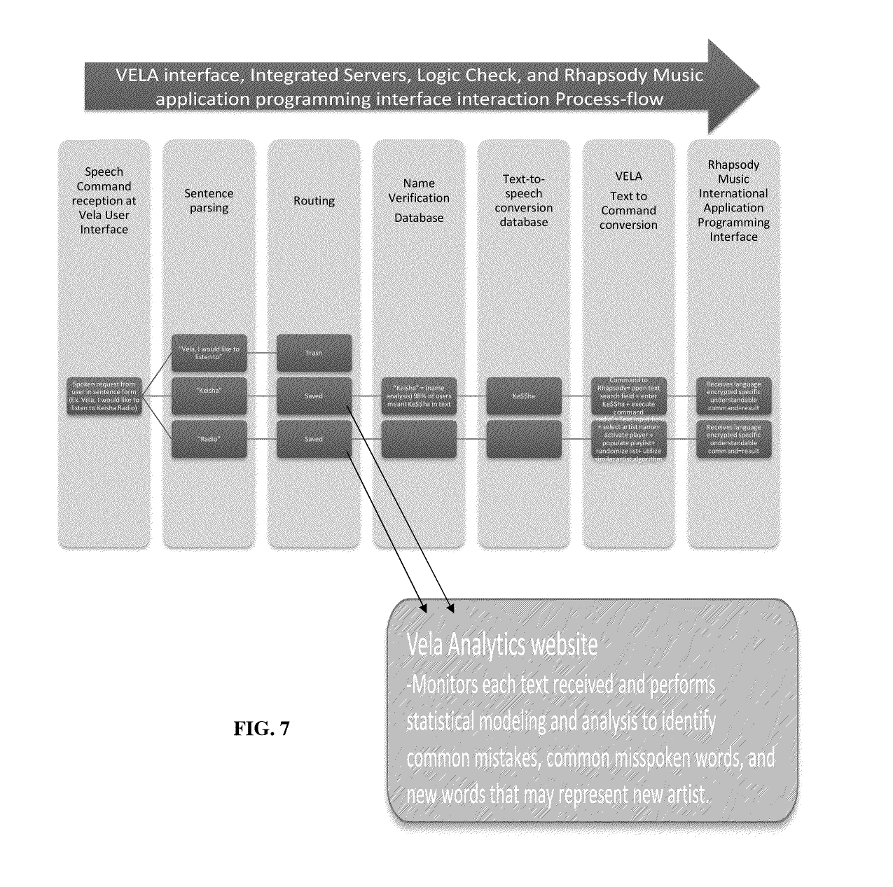

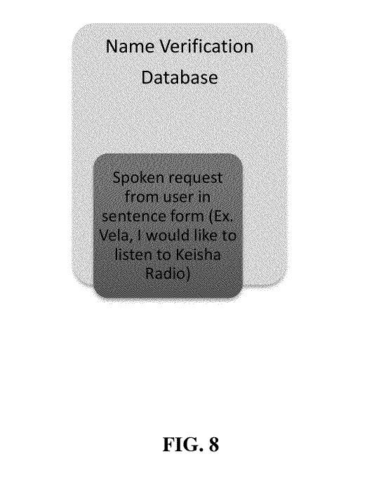

FIG. 4 illustrates an LCD display/touch screen interface 5 with an example of a search result for “Can't but me Love.” The LCD display/touch screen interface 5 has a list of matching audio files and a playlist for saving audio files.

FIG. 5 illustrates a visual and audio-interactive graphic application that understands human speech and has a music specific continually updated music vocabulary. Vela's visual interface is linked to speech-to-text, text-to-speech, artificial intelligence in the form of sentence parsing, database routing, special name verifications, speech-to-command processing, and encrypted application programming interface language communication with partnered music service Rhapsody music international to display what visually appears to be a music-specific smart interface that can understand human natural sentence structure to process commands for the user on the user's subscription-based music service. The interface processes text to speech and text to command and provide appropriate verbal responses to the human user to display understanding of the commands given by the user and to keep the user updated on the status of carrying out the request. FIGS. 5-8 illustrate a preferred embodiment that performs the following:
Performs speech-to-text conversion
Performs word parsing to separate nouns and verbs
Logic to determine text routing
Verification of music related text in a vela music text database
Resubmitted Music specific speech to text conversion
Speech to command conversion to Rhapsody music application programming interface
Rhapsody music application programming interface command control
Rhapsody music security authentication, re-authentication, and continual data export authentications
Interactive audio and visual response
Music player control
Multi database routing and logic
Complete mobile environment control

Recognize applicable action nouns for type of playback (for example “radio”+artist name will result in a mixture of music played in a similar class as the artist request. Just an “Artist name” will result in the artist's latest album to be played in order of song tracks.

The preferred embodiment has a specialized music vocabulary database that matches difficult artist names against a catalog of continually updated names lists. These names would not ordinarily be recognized by speech-recognition software because they are not spelled in a logic language text format. (For example, the artist Ke$$ha, whose name is spelled with dollar signs will not be translated correctly with normal speech, which would result in not finding the correct artist in our voice search. The preferred embodiment has a music specific noun catalog that is continuously updated to stay current with new artist information.

The preferred embodiment uses a wireless network to transmit data to multiple database for cross-check, accuracy, statistical analysis of commands to respond with the highest percentage accuracy result based on the continually updated databases made by the vela staff based on their continual research in the external music-specific information world. For example, FIG. 7 shows the interface between the preferred embodiment and Rhapsody music international as follows:
Authentication code to Rhapsody music international
Vela decrypts Rhapsody's acceptance language
Then vela calls on the Rhapsody music specific application programming interface for a noun (song title, artist name, or genre of music
Finds the requested song in the database

Then vela pairs the song request with the matching processed and translated speech command to decide what type of playlist should also be associated and play with the initial song request. For example, if vela has processed a “song name” and the word “radio” vela will return communicate the exact song requested to Rhapsody. Vela will also provide Rhapsody with a command to also generate a playlist of similar songs creating a radio-station like list to play autonomously without any further verbal requests from the human user. Vela then sends that data to the vela mobile player.

### User Action and Step Taken by Vela

1. Speech command reception at vela user interface.
a. At this stage a spoken request from user is given in sentence form (Ex. Vela, I would like to listen to Keisha Radio)

2. Sentence parsing.
a. VELA sentence parsing logic filters unneeded text and responds to actionable text.
b. For example: “I would like to listen to” is discarded, “Keisha” is recorded, and “Radio” is interpreted.

3. Routing.
a. VELA then sends the filtered information via wireless communication/mobile device channels to Vela's name verification database.

4. Name verification
a. Algorithmic logic is used to assess the word “Keisha”. The word “Keisha” is cross-referenced with the Vela artist names database. Vela logic identifies that in our user statistical analysis that 98% of the time “Keisha” means the spelling Ke$$ha in music noun terms.

5. Text to speech conversion
a. Vela converts text to our best guest text format. “Keisha” is changed to Ke$$ha. Our music format translated information is sent to the internet music site in order to find the correct artist based on actual spelling: Ke$$ha vs. Keisha.

6. Speech to command translation
a. Vela identifies certain key words and through our programmed logic, translates those keyword into actions in terms of the type of music playback. For example “Radio”+“Ke$$ha” will return the result of a music playlist of Ke$$ha songs plus other similar artist to Ke$$ha's genre of music.

7. Internet music database API interaction
a. VELA after receiving access to encrypted API data specific to each internet music sites (through partnerships), studies the API (application programming interface) unique to that internet music site and converts our filter nouns (ie: Ke$$ha) and filter keyword commands (ie. “radio”) into recognizable language specific to that internet music site.

8. Vela sends the results received from its request to the internet music site back to the Vela music player and converts the Internet music site response into Vela's customized music player format.

### Vela's Name Verification Database

Vela's name verification database (utilized in FIG. 8 of the Vela process flow)—

The name verification database is manually updated by Vela staff members continuously, based on new music information, including new artist releases, artist name changes, or any other relevant artist name data, in order to have a current vocabulary of artist names with correct spelling. Vela process uses this database to double check the correct, often unique spelling of these names, in order to accurately make the right request to our partner internet music service's online catalog of current music.

The foregoing description is, at present, considered to be the preferred embodiments of the present discovery. However, it is contemplated that various changes and modifications apparent to those skilled in the art, may be made without departing from the present discovery. Therefore, the foregoing description is intended to cover all such changes and modifications encompassed within the spirit and scope of the present discovery, including all equivalent aspects.

What is claimed is,:

1. A voice recognition system wherein a user may speak a title of an audio file and the title is received by a vehicle integrated microphone, the title further being recognized by a voice recognition software that is able to access a remote audio file database and the voice recognition software is able to play the audio file on a vehicle sound system.

2. A voice recognition system wherein a user may speak a title of an audio file and the title is received by a vehicle integrated microphone, the title further being recognized by a voice recognition software that is able to access a remote audio file database, the voice recognition software is able to display a list of matching audio files on a vehicle LCD screen and the user may choose the audio file to play the audio file on a vehicle sound system.

3. The voice recognition system of claim 2, wherein the user can choose the audio file via voice actuation.

4. The voice recognition system of claim 2, wherein the user can choose the audio file via touch screen actuation on the LCD screen.

5. A voice recognition system wherein a user may speak a title of an audio file and the title is received by a vehicle integrated microphone, the title further being recognized by a voice recognition software that is able to access a remote audio file database, the voice recognition software is able to recite a list of matching audio files and the user may choose the audio file to play the audio file on a vehicle sound system.

6. A voice recognition system of claim 5 wherein a partner API is used to interface with a partner database.

7. A voice recognition system comprising the following steps:
speech command reception at vela user interface;
at this stage a spoken request from user is given in sentence form (Ex. Vela, I would like to listen to Keisha Radio);
sentence parsing;
VELA sentence parsing logic filters unneeded text and responds to actionable text;
(For example: “I would like to listen to” is discarded, “Keisha” is recorded, and “Radio” is interpreted.)
Routing;
VELA then sends the filtered information via wireless communication/mobile device channels to Vela's name verification database;
name verification; algorithmic logic is used to assess the word “Keisha” the word “Keisha” is cross-referenced with the Vela artist names database, Vela logic identifies that in our user statistical analysis that 98% of the time “Keisha” means the spelling Ke$$ha in music noun terms;
text to speech conversion;
Vela converts text to our best guest text format “Keisha” is changed to Ke$$ha, our music format translated information is sent to the internet music site in order to find the correct artist based on actual spelling: Ke$$ha vs. Keisha;
speech to command translation;
Vela identifies certain key words and through our programmed logic, translates those keyword into actions in terms of the type of music playback (For example “Radio”+“Ke$$ha” will return the result of a music playlist of Ke$$ha songs plus other similar artist to Ke$$ha's genre of music);
internet music database API interaction;
VELA after receiving access to encrypted API data specific to each internet music sites (through partnerships), studies the API (application programming interface) unique to that internet music site and converts our filter nouns (ie: Ke$$ha) and filter keyword commands (ie. “radio”) into recognizable language specific to that internet music site;
Vela sends the results received from its request to the internet music site back to the Vela music player and converts the Internet music site response into Vela's customized music player format.
